(19) United States
(12) Patent Application Publication
(10) Pub. No.: US 2014/0182406 A1
(43) Pub. Date: Jul. 3, 2014

(54) REDUCTION GEAR DEVICE

(71) Applicants: HON HAI PRECISION INDUSTRY CO., LTD., New Taipei (TW); HONG FU JIN PRECISION INDUSTRY (WuHan) CO., LTD., Wuhan (CN)

(72) Inventors: YUN-LUNG CHEN, New Taipei (TW); DA-LONG SUN, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/011,919

(22) Filed: Aug. 28, 2013

(30) Foreign Application Priority Data
Dec. 28, 2012 (CN) 2012105825001

(51) Int. Cl. F16H 57/021; F16H 1/20

(52) U.S. Cl. CPC F16H 57/021; F16H 1/20
USPC 74/421 R

(57) ABSTRACT

A reduction gear device includes a mounting bracket, a drive gear, a first slave gear mounted on an inner side of the mounting panel, a second slave gear mounted on the inner side, and a first pivot shaft. The mounting bracket includes a mounting panel, and the mounting panel defines a first through hole. The first slave gear defines a first pivot hole. The second slave gear includes a second great gear portion and a second small gear portion. The second small gear portion engages with the first slave gear. The first pivot shaft includes a first head portion and a first neck portion. The first neck portion passes through the first through hole and the first pivot hole. The drive gear drives the second slave gear to rotate to drive the first slave gear to rotate.

### BACKGROUND

1. Technical Field

The present disclosure generally relates to a reduction gear device.

2. Description of Related Art

A vending machine includes a plurality of reduction gear devices. The reduction gear devices are driven by motors to rotate, thereby driving a loading device to select or drop products. The reduction gear device includes gears and two loading panels. The gears are mounted between the two loading panels. However, the gears may be not mounted to the loading panels stably, which prevents the gears engaging each other very well.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of one embodiment of a reduction gear device.

FIG. 2 is similar to FIG. 1, but viewed from another aspect.

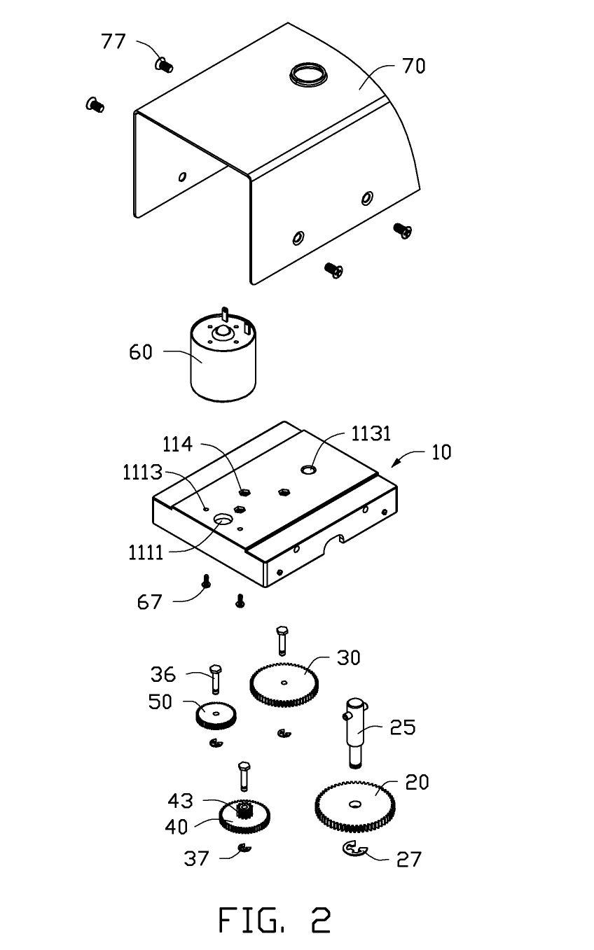

FIG. 3 is an assembled view of the reduction gear device of FIG. 1.

FIG. 4 is another assembled view of the reduction gear device of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

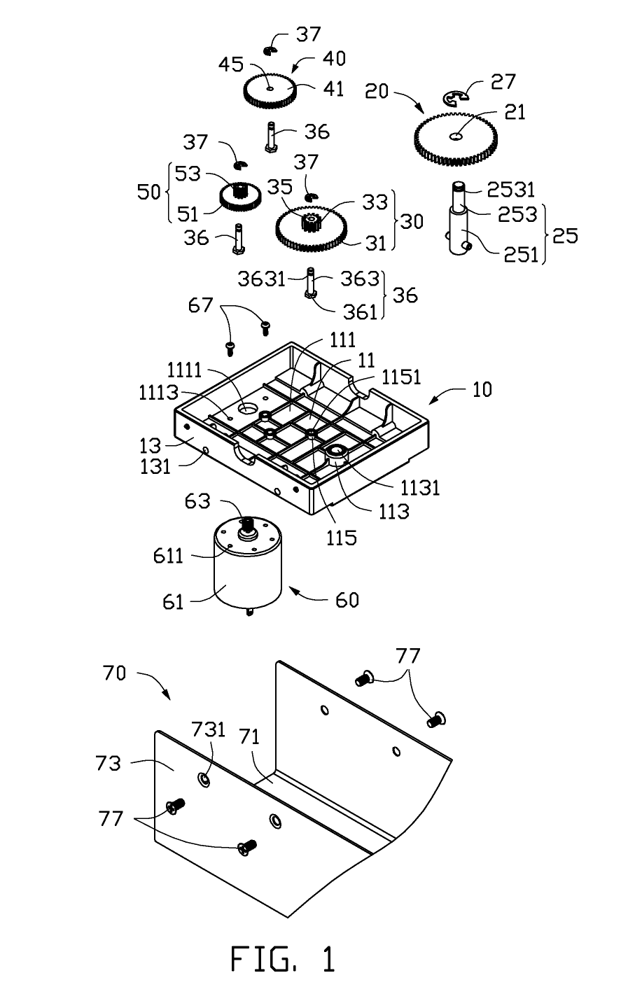

FIG. 1 shows that a reduction gear device, according to one embodiment, includes a mounting bracket 10, a first slave gear 20, a second slave gear 30, a third slave gear 40, and a fourth slave gear 50, a motor 60, and a mounting enclosure 70.

The mounting bracket 10 includes a mounting panel 11 and two side panels 13 extending from the mounting panel 11. The two side panels 13 are substantially parallel to each other and substantially perpendicular to the mounting panel 11. The mounting panel 11 includes a mounting panel body 111, a first mounting protrusion 113 extending inward from the mounting panel body 111, and three second mounting protrusions 115 extending inward from the mounting panel body 111. The first mounting protrusion 113 and the three second mounting protrusions 115 are substantially perpendicular to the mounting panel body 111. The mounting panel body 111 defines three recess portions 114 which recess from an outer side of the mounting panel body 111. The recess portion 114 is polygon-shaped. The mounting panel body 111 further defines a first through hole 1131 passing through the mounting panel body 111 and the first mounting protrusion 113, and three second through holes passing through the three recess portions 114 and the three mounting protrusions 115. The mounting panel body 111 further defines an opening 1111 and two securing holes 1113. Each side panel 13 defines two mounting holes 131.

The first slave gear 20 defines a first pivot hole 21 corresponding to the first through hole 1131. The reduction gear device further includes a first pivot shaft 25 and a first engaging member 27. The first engaging member 27 is E-shaped. The first pivot shaft 25 includes a first head portion 251 and a first neck portion 253 extending from the first head portion 251. The cross section of first neck portion 253 is less than that of the first head portion 251 taken along a plane substantially parallel to the first slave gear 20. The first neck portion 253 is used for passing through the first through hole 1131 and the first pivot hole 21. The first neck portion 253 defines a first slot 2531. The first engaging member 27 is used for engaging in the first slot 2531.

The second slave gear 30 includes a second great gear portion 31 and a second small gear portion 33 with the same axis as the second great gear portion 31. The second slave gear 30 defines a second pivot hole 35 which passes through the second great gear portion 31 and the second small gear portion 33. The reduction gear device further includes three second pivot shafts 36 and three second engaging members 37. The second engaging members 37 are E-shaped. The second pivot shaft 36 includes a second head portion 361 and a second neck portion 363 extending from the second head portion 361. The cross section of the second neck portion 363 is less than that of the second head portion 361 taken along a plane substantially parallel to the second great gear portion 31. The second neck portion 363 is used for passing through the second through hole 1151 and the second pivot hole 35. The second neck portion 363 defines a second slot 3631. The second engaging member 37 is used for engaging in the second slot 3631. The head portions are polygon-shaped.

The third slave gear 40 includes a third great gear portion 41 and a third small gear portion 43 with the same axis as the third great gear portion 41. The third slave gear 40 defines a third pivot hole 45 passing through the third great gear portion 41 and the third small gear portion 43. The third pivot hole 45 corresponds to the second through hole 1151.

The fourth slave gear 50 includes a fourth great gear portion 51 and a fourth small gear portion 53. The fourth slave gear 50 defines a fourth pivot hole 55 passing through the fourth great gear portion 51 and the fourth small gear portion 53. The fourth pivot hole 55 corresponds to the second through hole 1151.

The motor 60 includes a motor body 61 and a drive gear 63 connected to the motor body 61. The motor body 61 defines two associating holes 611 corresponding to the securing holes 1113. The drive gear 63 corresponds to the opening 1111 of the mounting bracket 10.

The mounting enclosure 70 includes a bottom wall 71 and two side walls 73 extending perpendicularly from the bottom wall 71. Each side wall 73 defines two fastening holes 731 corresponding to the mounting holes 131 of the mounting bracket 10.

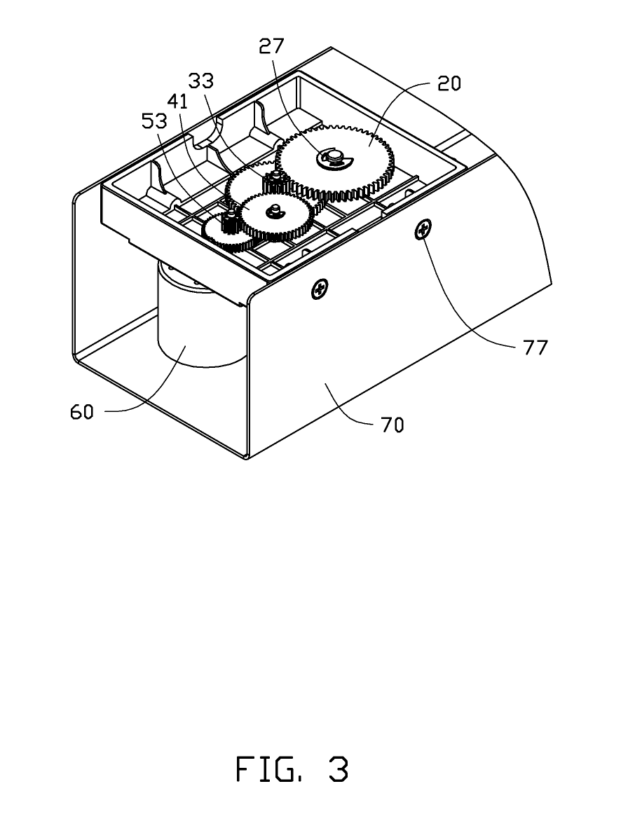

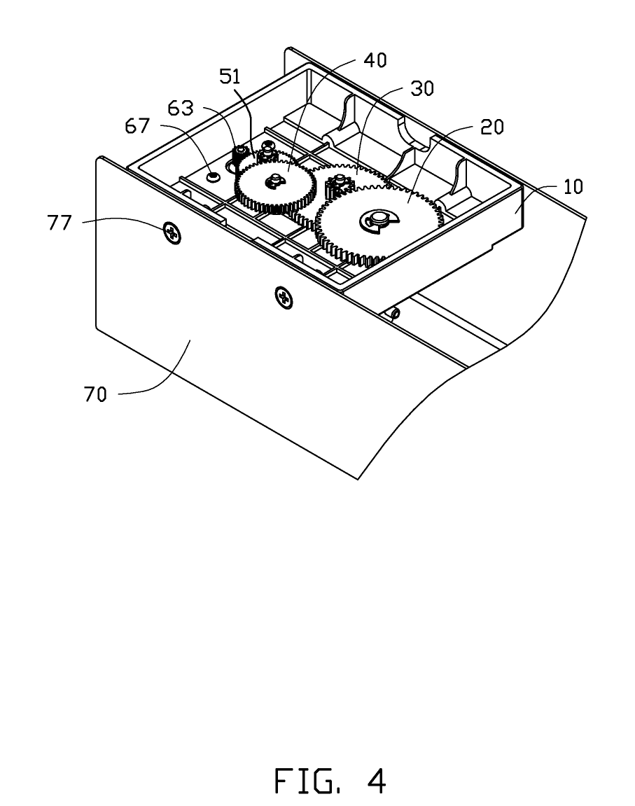

FIGS. 3 and 4 show that in assembly, the first slave gear 20 is placed on an inner side of the mounting panel 11 to enable the first pivot hole 21 to be aligned with the first through hole 1131. The first neck portion 253 of the first pivot shaft 25 passes through the first through hole 1131 and the first pivot hole 21 to enable the first slot 2531 of the first neck portion 253 to be exposed out of the first slave gear 20. The first engaging member 27 is engaged in the first slot 2531 to prevent the first pivot shaft 25 from moving out of the first pivot hole 21. The second pivot hole 35 of the second slave gear 30, the third pivot hole 45 of the third slave gear 40, and the fourth pivot hole 55 of the fourth slave gear 50 are aligned with the three second through holes 1151. The second small gear portion 33 of the second slave gear 30 engages with the first slave gear 20. The second great gear portion 31 of the second slave gear 30 engages with the third small gear portion 43 of the third salve gear 40. The third great gear portion 41 engages with the fourth small gear portion 53 of the fourth slave gear 50. At this time, the second great gear portion 31 of the second slave gear 30 and the fourth great gear portion 51 are located below their small gear portions. The third great gear portion 41 of the third slave gear 40 are located above the third great gear portion 41. The three second pivot shafts 36 passes through the three through holes 1151 and passes through the second pivot hole 35, the third pivot hole 45, and the fourth pivot hole 55 respectively. The three second engaging members 37 are engaged in the three second slots 3631 to pivotally mount the second slave gear 30, the third slave gear 40, and the fourth slave gear 50. At this time, the second head portion 361 of the second pivot shaft 36 is positioned in the recess portion 114.

The drive gear 63 of the motor 60 passes through the opening 1111 of the mounting bracket 10 to enable the drive gear 63 to engage with the fourth great gear portion 51 of the fourth slave gear 50. The associating holes 611 of the motor 60 are aligned with the securing holes 1113 of the mounting bracket 10. Two first fasteners 67 are secured in the securing holes 1113 and the associating holes 611 to secure the motor 60 to the mounting bracket 10. The mounting bracket 10 is placed between the two side walls 73 of the mounting enclosure 70 to enable the mounting holes 131 of the mounting bracket 10 to be aligned with the fastening holes 731 of the side walls 73. Four second fasteners 77 are secured in the fastening holes 731 and the mounting holes 131 to secure the mounting bracket 10 to the mounting enclosure 70.

The four slave gears are mounted to the mounting bracket 10 via the four pivot shafts. The reduction gear device has a simple structure and is capable of positioning the gear properly.

It is to be understood, however, that even though numerous characteristics and advantages of the embodiments have been set forth in the foregoing description, together with details of the structure and function of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A reduction gear device comprising:
a mounting bracket, the mounting bracket comprises a mounting panel, and the mounting panel defines a first through hole;
a drive gear;
a first slave gear mounted on an inner side of the mounting panel, the first slave gear defines a first pivot hole corresponding to the first through hole;
a second slave gear mounted on the inner side of the mounting panel, the second slave gear comprises a second great gear portion and a second small gear portion with the same axis as the second great gear portion, and the second small gear portion engages with the first slave gear; and
a first pivot shaft, the first pivot shaft comprises a first head portion and a first neck portion extending from the first head portion; and the first neck portion passes through the first through hole and the first pivot hole to enable the first head portion to be located on an outer side of the mounting panel;
wherein the second slave gear is configured to be driven by the drive gear to rotate to drive the first slave gear to rotate.

2. The reduction gear device of claim 1, further comprising a second pivot shaft, wherein the second slave gear defines a second pivot hole passing through the second great gear portion and the second small gear portion; the mounting panel further defines a second through hole corresponding to the second pivot hole and a recess portion recessed from the outer side of the mounting panel; the second pivot shaft comprises a second head portion and a second neck portion extending from the second head portion; the second neck portion passes through the second through hole and the second pivot hole to enable the second slave gear to be connected to the second pivot shaft; and the second head portion is received in the recess portion.

3. The reduction gear device of claim 2, wherein the recess portion is polygon-shaped, and the second head portion is polygon-shaped.

4. The reduction gear device of claim 3, further comprising an engaging member, wherein the second neck portion defines a slot; and the engaging member is engaged in the slot to prevent the second pivot shaft from moving out of the second pivot hole.

5. The reduction gear device of claim 1, further comprising a third slave gear mounted on the inner side of the mounting panel; wherein the third slave gear comprises a third great gear portion and a third small gear portion; the third small gear portion engages with the second great gear portion; and the drive gear is configured to rotate to drive the second slave gear and the third slave gear to rotate, thereby driving the first slave gear to rotate.

6. The reduction gear device of claim 5, further comprising a fourth slave gear mounted on the inner side of the mounting panel, wherein the fourth slave gear comprises a fourth great gear portion and a fourth small gear portion with the same axis as the fourth great gear portion; the third great gear portion engages with the fourth small gear portion; and
the fourth great gear portion engages with the drive gear.

7. The reduction gear device of claim 5, wherein the third small gear portion is located between the mounting panel and the third great gear portion.

8. The reduction gear device of claim 1, further comprising a mounting enclosure, wherein the mounting bracket further comprises two side panels extending from the mounting panel; each of the two side panels defines two mounting holes; the mounting enclosure comprises two side walls; and each of the two side walls defines two fastening holes corresponding to the two mounting holes.

9. The reduction gear device of claim 1, wherein the mounting panel comprises a mounting panel body and a first mounting protrusion extending inward from the mounting panel body; the first through hole passes through the first mounting protrusion and the mounting panel body; and the first mounting protrusion is located between the first slave gear and the mounting panel body.

10. A reduction gear device comprising:
a mounting bracket, the mounting bracket comprises a mounting panel, and the mounting panel defines a first through hole and an opening;
a motor, the motor comprises a motor body and a drive gear connected to the motor body;
a first slave gear, the first slave gear defines a first pivot hole corresponding to the first through hole;
a second slave gear mounted on an inner side of the mounting panel, the second slave gear comprises a second great gear portion and a second small gear portion with the same axis as the second great gear portion, and the second small gear portion engages with the first slave gear; and
a first pivot shaft, the first pivot shaft passes through the first through hole and the first pivot hole to attach the first slave gear to the inner side of the mounting panel;
wherein the drive gear passes through the opening to be located on the inner side of the mounting panel and to enable the motor body to be located on an outer side of the mounting panel; and the second slave gear is configured to be driven by the drive gear to rotate to drive the first slave gear to rotate.

11. The reduction gear device of claim 10, further comprising a second pivot shaft, wherein the second slave gear defines a second pivot hole passing through the second great gear portion and the second small gear portion; the mounting panel further defines a second through hole corresponding to the second pivot hole and a recess portion recessed from the outer side of the mounting panel; the second pivot shaft comprises a second head portion and a second neck portion extending from the second head portion; the second neck portion passes through the second through hole and the second pivot hole to enable the second slave gear to be connected to the second pivot shaft; and the second head portion is received in the recess portion.

12. The reduction gear device of claim 11, wherein the recess portion is polygon-shaped, and the second head portion is polygon-shaped.

13. The reduction gear device of claim 12, further comprising an engaging member, wherein the second neck portion defines a slot; and the engaging member is engaged in the slot to prevent the second pivot shaft from moving out of the second pivot hole.

14. The reduction gear device of claim 10, further comprising a third slave gear mounted on the inner side of the mounting panel; wherein the third slave gear comprises a third great gear portion and a third small gear portion; the third small gear portion engages with the second great gear portion; and the drive gear is configured to rotate to drive the second slave gear and the third slave gear to rotate, thereby driving the first slave gear to rotate.

15. The reduction gear device of claim 14, further comprising a fourth slave gear mounted on the inner side of the mounting panel, wherein the fourth slave gear comprises a fourth great gear portion and a fourth small gear portion with the same axis as the fourth great gear portion; the third great gear portion engages with the fourth small gear portion; and the fourth great gear portion engages with the drive gear.

16. The reduction gear device of claim 15, wherein the third small gear portion is located between the mounting panel and the third great gear portion.

17. The reduction gear device of claim 10, further comprising a mounting enclosure, wherein the mounting bracket further comprises two side panels extending from the mounting panel; each of the two side panels defines two mounting holes; the mounting enclosure comprises two side walls; and each of the two side walls defines two fastening holes corresponding to the two mounting holes.

18. The reduction gear device of claim 10, wherein the mounting panel comprises a mounting panel body and a first mounting protrusion extending inward from the mounting panel body; the first through hole passes through the first mounting protrusion and the mounting panel body; and the first mounting protrusion is located between the first slave gear and the mounting panel body.
